(19) United States
(12) Patent Application Publication
(10) Pub. No.: US 2004/0129654 A1
(43) Pub. Date: Jul. 8, 2004

(54) Electric field pressure filtration of biopolymers

(76) Inventor: Clements Posten, (US)

Correspondence Address: NIXON PEABODY, LLP, 401 9TH STREET, NW, SUITE 900, WASINGTON, DC, 20004-2128, US

(21) Appl. No.: 10/450,828

(22) PCT Filed: Dec. 20, 2001
(86) PCT No.: PCT/EP01/15151

(51) Int. Cl. C02F 1/00

(52) U.S. Cl. 210/807

(57) ABSTRACT

A difference in pressure is generated between the two sides of a filter medium (1) so that the liquid (2) charged with biopolymers (3), for instance xanthan, that is fed through the inlet (5) goes through the filter medium (1), wherein the biopolymers (3) are retained by the filter medium (1). As opposed to crossflow filtration, the main direction of movement (4) of the liquid (2) is determined by the difference in transmembrane pressure. A cathode (7) is arranged under the filter membrane (1). A membrane serving as anode (8) is arranged on the opposite side of the process chamber (9). An electrical field is built up between the electrodes (7, 8). Due to the fact that the biopolymer components (3) carry a negative surface charge, a force moving in the direction of the anode (8), and, hence, against the main direction of movement (4) of the liquid (2), impinges upon said components in the electrical field (8), whereby the concentration of biopolymers is reduced in the surroundings of the filter medium (1) and filtration speed is increased. A surprising, additional effect is that the electrical field leads to reinforced coagulation tendency of the biopolymers (3) which further favors filtration by the formation of agglomerates.

### FIELD OF THE INVENTION

The present invention relates to a method for the separation of biopolymers from a liquid, the procedure comprising a filtration step. The invention further relates to a filter apparatus for the separation of a disperse phase, and in particular of biopolymers, from a liquid.

### BACKGROUND OF THE INVENTION

Among the most industrially important biopolymers is the polysaccharide xanthan. A common method for the separation of xanthan is described by Y.-M. Lo, S.-T. Yang and D. B. Min in “Ultrafiltration of Xanthan Gum Fermentation Broth: Process and Economic Analysis” (Journal of Food Engineering, 32, 219-237 (1997)). A xanthan containing biosuspension is concentrated by means of an ultrafiltration unit, and treated with isopropanol in order to precipitate the xanthan. Typically, the ultrafiltration is a cross flow filtration, that is the main direction of motion of the suspension liquid occurs perpendicular to the direction of filtration, thus essentially parallel to the filtration medium. This is necessary to prevent the filtration medium from blockage and clogging, which is commonly known as “membrane fouling”. Membrane fouling greatly reduces the permeability of the filtration medium, and possibly almost completely disrupts the filtration process. The major part of the operating costs for the ultrafiltration is caused by the energy consumed by the pumps providing for motion of the liquid. Since the xanthan content in the liquid increases during the process of ultrafiltration, the viscosity of the concentrated suspension increases as well, causing an increase in the necessary pumping capacity. Ultrafiltration merely achieves an increase in xanthan concentration, but does not provide for actual separation of xanthan, since it is necessary that the xanthan containing suspension liquid remains well pumpable, as to maintain the functioning of the cross flow filtration apparatus.

Subsequent addition of isopropanol to the concentrated suspension causes precipitation of xanthan, which then is collected by means of filtration or centrifugation. After the step of filtration or centrifugation, the isopropanol is recovered by distillation. The process of distillation is fairly energy consuming, since it is necessary to provide heat of vaporization for the whole amount of alcohol used during precipitation. On the other hand, it is not possible to forego the step of distillation, in order to recycle a major part of the isopropanol, and to avoid high alcohol concentration in wastewater and high consumption of isopropanol. However, loss of the organic solvent isopropanol is inevitable when following conventional procedures, since alcohol is also contained in the xanthan fraction, separated by filtration or centrifugation, respectively.

### DESCRIPTION OF THE INVENTION

Due to the problems related to recycling of alcohol as well as loss of alcohol, it is an object of the present invention to provide a method for separation of biopolymers from a liquid, and especially for the separation of xanthan, which does not necessitate a step of precipitation with isopropanol, and which uses a significantly lower amount of total energy, compared to common procedures.

This goal is achieved by providing a method for separation of biopolymers form a liquid, and especially for separation of polysaccharides such as xanthan or for separation of poly hydroxybutyric acid, which contains a step of electric field pressure filtration. During the step of electric field pressure filtration, a pressure differential is built up between both sides of the filtration medium, the filtration medium being suitable for filtration of biopolymers. Additionally, an electric filed is applied in the surrounding of the filtration medium in such a way that a force acting on the biopolymers is created, which operates in a direction opposite to the main direction of motion of the liquid containing the biopolymers. Therefore, the main direction of motion of the liquid within a filtration cavity is fixed in a direction extending through the filtration medium, and not across the filtration medium, as it is the case for cross flow filtration. The biopolymers, which carry a charge due to dissociated functional groups, experience a force away from the filtration medium caused by the applied electric filed. The electric field is oriented in way that lines of electric flux run in a direction perpendicular to a surface of the filtration medium, or form an acute angle with a surface of the filtration medium. Electrokinetic effects occur, and biopolymers are moved away from the filtration medium by a process of electrophoresis. This causes a lowering of biopolymer concentration in the vicinity of the filtration medium. Further, the kinetics of filtration is increased due to reduced viscosity and prevention of pore blocking within the filtration medium. The liquid used is mainly an aqueous medium; the use of organic solvents is not needed.

An additional and surprising effect is the enhanced tendency towards coagulation exhibited by the biopolymers, caused by the electric field. This in turn favors the filtration through formation of agglomerates.

Further surprisingly, in the production of xanthan according to a method of the present invention, it is possible not only to forego the use of an organic liquid and thus to avoid the related step of distillation, but also to forego the preceding step of ultrafiltration using a cross flow filtration apparatus. This is beneficial for the operating costs as well as for the investment cost for a xanthan production facility, since the use of a cross flow filtration apparatus is avoided.

Preferably a membrane is used as the filtration medium, which advantageously is an ion-exchanging membrane. Alternatively, a filtration fabric or tissue, or a rigid porous compound is used as filtration medium.

In an especially advantageous embodiment of the present invention, the pressure differential is larger than the difference between atmospheric pressure and vacuum. This causes an increase in filtration speed.

The pressure differential is advantageously created by hydrostatic pressure exhibited by a fluid, in a hydraulic fashion by at least one pump, by means of gaseous pressure differential, or by the radially hydrostatic pressure built up due to centrifugal forces.

In an especially advantageous embodiment of the present invention, the step of filtration is performed with an apparatus, in which one or more hollow support elements are disposed within a chamber, and equipped with a filtration medium. The chamber contains an inlet through which is introduced a xanthan-charged liquid. The pressure differential is built up between the exterior and the interior of the support element, and the main direction of movement of the liquid is therefore defined to occur from the exterior to the interior and through the filtration medium. The liquid runs off the interior of the support element through a filtrate drain. By connecting at least two electrodes with an electric voltage source, an electric field is created. The electrodes are arranged in a way that a force is created in the vicinity of the filtration medium, acting on the biopolymers and operating in a direction opposite to the main direction of motion of the liquid.

According to another advantageous embodiment of the present invention, the step of filtration is performed in a filter press equipped with at least two electrodes, or in a pressure filtration apparatus equipped with at least two electrodes. When working with small batches, the step of filtration is preferably performed within a suction filter equipped with at least two electrodes.

According to another advantageous embodiment of the present invention, the method contains a step in which the ion concentration of the liquid is lowered. This step is preferably performed before the step of filtration, and is advantageously achieved using an ion exchanger, or by dialysis or electrodialysis. Advantageously, the pressure differential and the electric field are applied at the same time.

The method according to the present invention is especially advantageous in cases when the liquid contains additional solid particles besides biopolymers. According to the instant invention, the additional solid particles are advantageously separated from the liquid either during the step of filtration or before the step of filtration, preferably by centrifugation. In case the additional solid particles are separated from the liquid during the step of filtration, the presence of the electric fields is beneficial for the separation of the solid particles. Since solid particles in an aqueous medium in general carry a surface charge, electrophoretic effects are at work which defer build up of filter cake of solid particles on the filtration medium. This causes a beneficial effect for the kinetics of the filtration process.

Preferably, the filtration medium is disposed between at least one pair of electrodes, a pair consisting of anode and cathode. Advantageously, the anode is at least partially made of a nickel based alloy, graphite or platinum. One of the electrodes possibly is a metallic support beneath the filtration medium.

In another advantageous embodiment of the instant invention, the filtration medium is at least partially formed from an electrically conducting material and is itself used as an electrode.

Providing a filtration apparatus for separating a disperse phase, and especially biopolymers, from a liquid, provides a further solution to the underlying problem that makes the present invention useful. The filtration apparatus comprises one or more hollow support elements equipped with a filtration medium, the hollow support elements arranged within a chamber for receiving a liquid charged with a disperse phase through an inlet within the chamber. Between the exterior and interior of each support element a pressure differential can be created, which defines the main direction of motion of the liquid from the exterior of the support element to its interior. Furthermore, the filtration apparatus comprises at least two electrodes, which are arranged in such a way that by connecting the electrodes with an electric voltage source an electric filed can be applied, which causes a force acting on the disperse phase in a direction opposite of the direction of main motion of the liquid. The liquid runs off from the interior of the support element through a filtrate drain.

In a preferred embodiment of the present invention, a support element is provided in the shape of a cylinder or a prism, and the filtration medium at least partially covers the generated surface of said support element. Advantageously, an electrode is annularly disposed around the support element.

In another preferred embodiment, each support element is provided in the shape of a plate, disc or convex disc, having two abutting faces, wherein the filtration medium covers at least partially at least one of the two abutting faces. Advantageously, the support elements are displaced either horizontally or vertically.

In yet another preferred embodiment, at least one electrode is integrated into each support element. Preferably the at least one electrode is provided in the shape of a plate, disc or convex disc.

Preferably, the filtration apparatus comprises a plurality of support elements arranged for operating in parallel fashion.

### BRIEF DESCRIPTION OF THE DRAWINGS

The present invention is now described in conjunction with the following drawings, in which exemplary embodiments are displayed. The drawings are schematized for the sake of clarity, and are not according to scale.

FIG. 1 displays a schematic diagram illustrating the basic principles governing the step of filtration according to the instant invention;

FIG. 2 displays a schematic side cross section of a filtration apparatus according to the present invention, not shown to scale, the filtration apparatus having convex-disc-shaped support elements; and

FIG. 3 displays a schematic side cross section of a filtration apparatus according to the instant invention, not shown to scale, the filtration apparatus having a cylindrical support element.

### DETAILED DESCRIPTION OF THE INVENTION

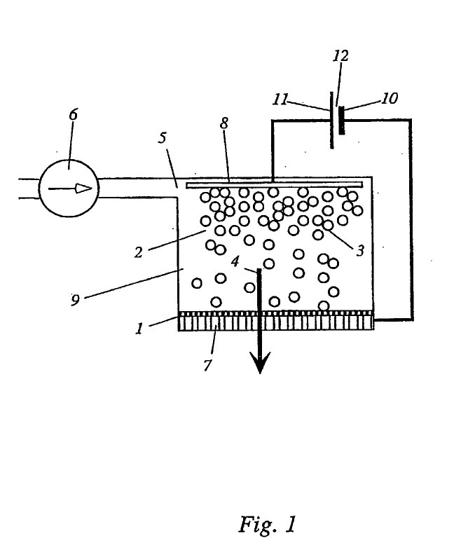

In FIG. 1, the basis principles of a method according to the instant invention are schematically illustrated. A pressure differential is created between two sides of a filtration medium 1, for example a membrane suitable for the filtration of biopolymers. An aqueous liquid 2 charged with macromolecules or colloids formed from a biopolymer to be separated 3, for example xanthan, enters through inlet 5. The pressure differential causes the aqueous liquid 2 to penetrate through the filtration medium 1, and therefore initiates a process of filtration, during which the biopolymer 3 is prevented from passing through the filtration medium 1. The main direction of motion 4 of the liquid 2 is defined by the pressure differential across the membrane, contrary to a cross flow filtration process. The pressure differential is, for example, applied through inlet 5 and in a hydraulic fashion using a pump 6. Underneath the filtration medium 1 there is disposed a metallic support 7 operating as cathode. On the opposite side of the filtration cavity 9, there is disposed a plate operating as anode 8, and, for example, is manufactured from Hastelloy. The cathode 7 is connected with the negative pole 10 of a source for direct current 12, and the anode 8 is connective to this positive pole. This way, an electric field is generated between the two electrodes. Since parts of the biopolymers 3 carry a negative surface charge due to dissociated OH-groups, a force in direction towards anode 8 and opposite the main direction of motion of the liquid is 2 acting on the biopolymers. Above a critical electric field strength, which is required so that the electric field force overcomes a resistance force exhibited by the liquid 2 running off through the filtration medium 1, the parts of the biopolymers 3 move in an electrophoretic fashion towards the anode 8. This process causes a lowering of the concentration of biopolymer in vicinity of the filtration medium, and enhances speed of filtration. In addition, due to the law of conservation of electroneutrality of a given system, the liquid 2 is positively charged, and also experiences an electric force. This electric force causes a process of electro-osmosis and supports the movement of the liquid in direction of the cathode 7, superimposing an electro-osmotic pressure onto the hydraulic pressure differential. After completion of the separation the biopolymer mass remaining in the filtration cavity 9 is possibly dewatered by application of a gaseous pressure differential, and is subsequently collected.

In order to maintain a low flow of an electric current, the conductivity of liquid 2 is reduced using an ion exchanger (not shown), before subjected to the above-described filtration process.

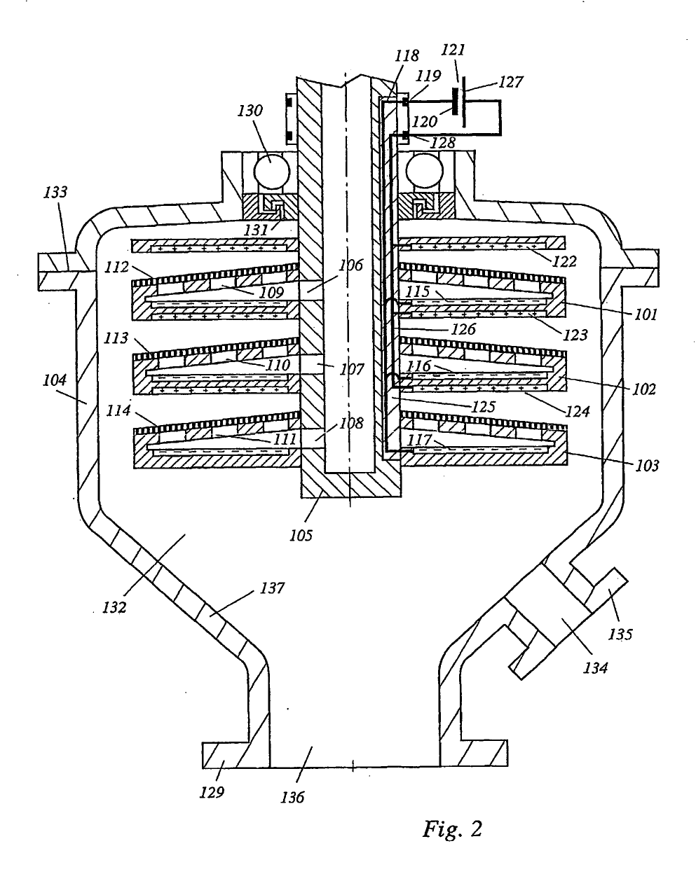

In FIG. 2 displayed is a schematic cross sectional view, not to scale, of a filtration apparatus according to the instant invention. The hollow, convex-disc-shaped support elements 101, 102, 103 are made from electrically non-conducting plastic material, and are disposed inside of chamber 104. The support elements 101, 102, 103 are affixed to hollow shaft 105. The interior of each of the support elements 101, 102, 103 is connected with the interior of hollow shaft 105 through filtrate draining bores 106, 107, 108. Each of the support elements 101, 102, 103 displays on its exterior surface, the exterior surfaces having openings 109, 110, 111 extending through the surfaces, a filtration medium 112, 113, 114, which is for example a membrane suitable for filtration of biopolymers. By applying a vacuum at the filtrate side, that is applying a vacuum to a cavity in which filtrate is collected, and which is connected to the interior of the hollow shaft, a pressure differential is created between the interior and exterior of each of the support elements 101, 102, 103. Inside each of the support elements 101, 102, 103 and below the filtration medium there are disposed electrodes 115, 116, 117, which are connected via a shielded cable 118 disposed within an isolating body 125, and a slip ring 119 with the negative pole 120 of a direct current source 121. Therefore, the electrodes are connected to operate as cathodes 115, 116, 117. Opposite each cathode, and on the other side of the corresponding filtration medium 112, 113, 114, there are disposed electrodes 122, 123, 124. The electrodes are connected via a shielded cable 126 disposed within an isolating body 125, and a slip ring 128 with the positive pole 127 of a direct current source 121, and act therefore as anodes 122, 123, 124. Therefore, an electric field is applicable between the pairs of electrodes 115/122, 116/123, and 117/124. The hollow shaft 105 is supported by cantilever bearings. Only one bearing 130 is explicitly shown, which is sealed against the filtration cavity 132 by way of labyrinth-sealing. The chamber can be opened through flanged connection 133. In addition, the chamber comprises an inlet 134 with inlet flange 135, and an outlet 136 with outlet flange 129.

In operation, a liquid charged with a disperse phase such as xanthan is introduced into the filtration cavity 132 of chamber 194 through inlet 134. The liquid is filtered through filtration medium 112, 113, 114 by means of an applied pressure differential, enters the interior of support elements 101, 102, 103, and is guided through filtrate draining bores 106, 107, 108 and through the interior of hollow shaft 105 to a filtrate collecting container (not shown). Outlet 136 is closed. A force operates in a direction opposite to the main direction of motion of the liquid on the disperse phase, which lowers the concentration of the disperse phase in vicinity of filtration medium 112, 113, 114, and enhances the speed of the filtration process. The disperse phase is precipitated at anodes 122, 123, 124 and together with the last portion of liquid running off the filtration cavity 132 also at filtration medium 112, 113, 114. After completion of the filtration, the precipitated disperse phase is collected, and to this end, a torsional vibration is applied to hollow shaft 105 and support elements 101, 102, 103. The precipitated disperse phase spins off the support elements 101, 102, 103, and slides down slanted wall 137 into the lower part of chamber 104, and towards outlet 136.

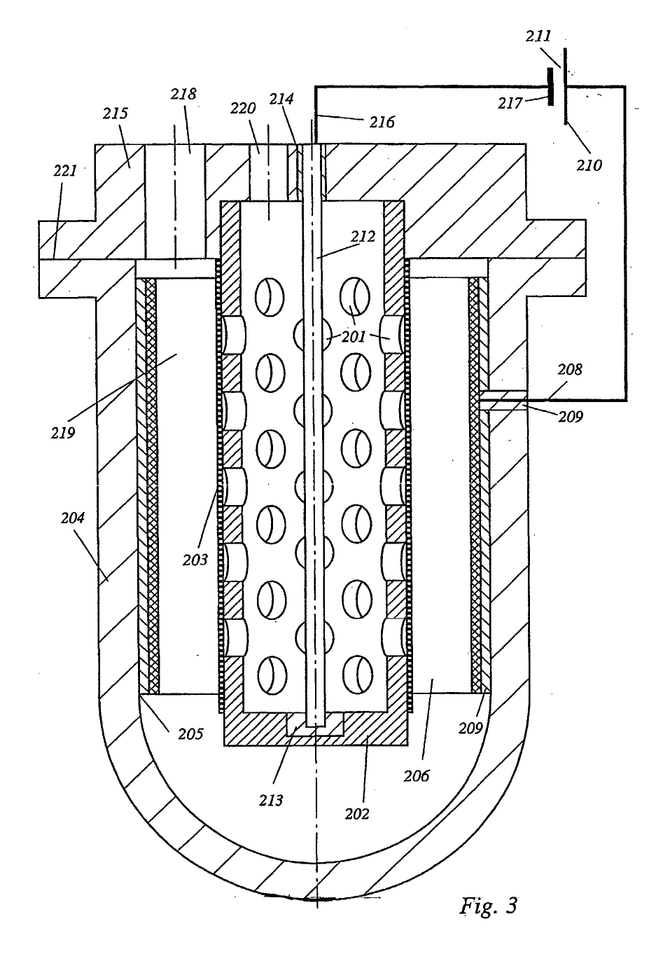

In FIG. 3 displayed is a schematic cross sectional view, not to scale, of another filtration apparatus according to the present invention.

The apparatus contains a hollow cylindrical support element 202, which has openings 201, and which is covered with a filtration medium 203, such as a membrane suitable for filtration of biopolymers. The support element is disposed inside a pressure container 204. Along the container wall 205 there is disposed a cylindrical electrode 206, electrically isolated from the container wall 205 through an isolating layer 207, and surrounding the support element. Electrode 206 is connected with direct current source 211 through an electric cable 208 that is guided via isolating body 209 through the wall of pressure container 204. The electrode 206 is connected with the positive pole 210 of direct current source 211, and operates therefore as anode 206. Inside of the support element 202 there is disposed a rod-shaped electrode 212, supported by two isolating pieces 213 and 214, the isolating pieces disposed within support element 201 and lid 215, respectively. The rod-shaped electrode 212 is connected via electric cable 216 with negative pole 217 of direct current source 211, and therefore operates as cathode 212. An inlet 218 provides access to filtration cavity 219. The inlet 218 extends through lid 215. Lid 215 can be separated from the remaining part of pressure container 204 by means of flange 221. An outlet 220 provides access from the interior of support element 202 to a filtrate draining pipe (not shown).

In operation, a liquid charged with a disperse phase such as xanthan is pumped through inlet 218 into the interior of the pressure container 204. The pump (not shown) also creates a pressure differential between interior and exterior of support element 202, being the driving force for the main direction of motion of the liquid extending through the filtration medium 203. The liquid enters the interior of support element 202 through openings 201, and the filtrate exits the interior through outlet 220. The electric field created between electrodes 206 and 212 exhibits a force on the disperse phase in a direction opposite the main direction of motion of the liquid. Therefore, the concentration of the disperse phase in the vicinity of the filtration medium 203 is lowered, causing an increase in filtration speed, and preventing clogging of pores of the filtration medium 203.

What is claimed is:

1. A method for separating biopolymers from a liquid comprising a step of:
performing a filtration;
wherein in the step of filtration the main direction of motion of the liquid is caused by a pressure differential between both sides of a filtration medium; and
wherein in the vicinity of the filtration medium an electric field is applied creating a force operating on the biopolymers in opposite direction to the main direction of motion of the liquid.

2. The method according to claim 1, characterized in that the biopolymers consist at least in part of polysaccharides.

3. The method according to claim 2, characterized in that the polysaccharides consist at least in part of xanthan.

4. The method according to claim 1, characterized in that the biopolymers consist at least in part of poly hydroxybutyric acid.

5. The method according to claim 1, characterized in that a membrane is used as filtration medium.

6. The method according to claim 5, characterized in that an ion exchanging membrane is used as membrane.

7. The method according to claim 1, characterized in that a filtration fabric is used as filtration medium.

8. The method according to claim 1, characterized in that a rigid porous compound is used as filtration medium.

9. The method according to claim 1, characterized in that the pressure differential is larger than a difference between surrounding atmospheric pressure and a vacuum.

10. The method according to claim 1, characterized in that the pressure differential is created by hydrostatic pressure exhibited by a fluid.

11. The method according to claim 1, characterized in that the pressure differential is created in hydraulic fashion by at least one pump.

12. The method according to claim 1, characterized in that the pressure differential is created by a gaseous pressure difference.

13. The method according to claim 1, characterized in that the pressure differential is created by radial hydrostatic pressure built up due to centrifugal forces.

14. The method according to claim 1, characterized in that the step of filtration is performed with an apparatus, the apparatus comprising:
(a) a chamber having an inlet through which a liquid charged with biopolymers is introduced into the chamber;
(b) at least one support element equipped with a filtration medium, disposed inside the chamber and displaying an exterior side, and an interior side as well as an outlet, for draining liquid, whereby a pressure differential is created between the exterior side and the interior side of the at least a support element, the pressure differential defining the main direction of motion of the liquid as extending from the exterior side to the interior side and passing through the filtration medium; and
(c) at least two electrodes arranged in a way that by connecting the electrodes with an electric voltage source an electric field is created in the vicinity of the filtration medium, whereby a force is created acting on the biopolymers in a direction opposite of the main direction of motion of the liquid.

15. The method according to claim 11, characterized in that the step of filtration is performed with a filter press equipped with at least two electrodes.

16. The method according to claim 11, characterized in that the step of filtration is performed with a pressure filtration apparatus equipped with at least two electrodes.

17. The method according to claim 12, characterized in that the step of filtration is performed with a suction filter equipped with at least two electrodes.

18. The method according to claim 1, characterized in that the method comprises a step of:
lowering a concentration of ions in the liquid.

19. The method according to claim 18, characterized in that the step filtration is preceded by the step of lowering the ion concentration of the liquid.

20. The method according to claim 18 or 19, characterized in that the step of lowering the concentration of ions in the liquid is performed in a same filtration cavity as the step of filtration.

21. The method according to claim 18 or 19, characterized in that the ion concentration in the liquid is lowered by means of an ion exchanger.

22. The method according to claim 18 or 19, characterized in that the ion concentration in the ion concentration in the liquid is lowered by means of dialysis or electodialysis.

23. The method according to claim 1, characterized in that steps of applying an electric field and creating a pressure differential are performed subsequently.

24. The method according to claim 1, characterized in that steps of applying an electric field and creating a pressure differential are performed at a same time.

25. The method according to claim 1, characterized in that the liquid contains additional solid particles besides the biopolymers.

26. The method according to claim 25, characterized in that the additional solid particles are separated from the liquid during the step of filtration.

27. The method according to claim 25, characterized in that the additional solid particles are separated from the liquid before the step of filtration is performed.

28. The method according to claim 27, characterized in that the additional solid particles are separated by centrifugation.

29. The method according to claim 1, characterized in that the filtration medium is disposed in between at least one pair of electrodes, comprising an anode and a cathode.

30. The method according to claim 29, characterized in that an anode employed is at least partially made of a nickel based alloy.

31. The method according to claim 29, characterized in that an anode employed is at least partially made of a graphite.

32. The method according to claim 29, characterized in that an anode employed is at least partially made of platinum.

33. The method according to claim 1, characterized in that the filtration medium is at least partially made of electric conducting material and is used as an electrode.

34. A method for separating biopolymers from a liquid, wherein the liquid is absent an organic solvent causing precipitation of biopolymers, and comprising a step of:
performing a filtration;
wherein in the step of filtration the main direction of motion of the liquid is caused by a pressure differential between both sides of a filtration medium; and
wherein in the vicinity of the filtration medium an electric field is applied creating a force operating on the biopolymers in opposite direction to the main direction of motion of the liquid.

35. A method for manufacturing of xanthan, comprising at least a step of fermentation, and at least a step of separation of produced xanthan-biopolymers from the fermentation liquid, whereby the separation is performed according to claim 1.

36. A filtration apparatus for separation of a disperse phase, and especially for separation of biopolymers from a liquid, comprising:
(a) a chamber having an inlet for introducing a liquid charged with a disperse phase into the chamber;
(b) at least one support element disposed inside the chamber, the support element comprising a filtration, an interior side and an exterior side, and a filtrate draining bore for draining a liquid, whereby a pressure differential is created between the interior side and the exterior side defining a main direction of motion of the liquid from the exterior side to the interior side and extending through the filtration medium; and
(c) at least two electrodes disposed for creating an electric field in the vicinity of the filtration medium creating a force operating on the disperse phase in a direction opposite to the direction of main motion of the liquid, the electric field created when connecting the electrodes with an electric voltage source.

37. The filtration apparatus according to claim 36, characterized in that the support element is in the shape of a prism, the filtration medium at least partially covering the generated surface of said support element.

38. The filtration apparatus according to claim 36, characterized in that the support element is in the shape of a cylinder, the filtration medium at least partially covering the generated surface of said support element.

39. The filtration apparatus according to claim 36, characterized in that the at least one electrode annularly surrounds said support element.

40. The filtration apparatus according to claim 36, characterized in that the support element is provided in shape of a plate, disc or convex disc, having two abutting faces, wherein the filtration medium covers at least partially at least one of the two abutting faces.

41. The filtration apparatus according to claim 40, characterized in that the support is disposed horizontally.

42. The filtration apparatus according to claim 40, characterized in that the support element is disposed vertically.

43. The filtration apparatus according to claim 36, characterized in that at least one electrode is integrated into the support element.

44. The filtration apparatus according to claim 40, characterized in that at least one electrode is provided in shape of a plate, disc or convex disc.

45. The filtration apparatus according to claim 36, characterized in that the filtration apparatus comprises a plurality of support elements for operating in parallel fashion.
